(19) United States
(12) Patent Application Publication
(10) Pub. No.: US 2025/0301055 A1
(43) Pub. Date: Sep. 25, 2025

(54) RELAY SYSTEM, RELAY DEVICE, AND PROGRAM

(71) Applicant: DENSO CORPORATION, Kariya-city (JP)

(72) Inventor: TAICHI ITAGAWA, Kariya-city (JP)

(21) Appl. No.: 19/045,893

(22) Filed: Feb. 5, 2025

(30) Foreign Application Priority Data
Mar. 21, 2024 (JP) 2024-045092

(51) Int. Cl. H04L 69/08; H04L 12/40

(52) U.S. Cl. CPC H04L 69/08; H04L 12/40; H04L 2012/40215; H04L 2012/40273

(57) ABSTRACT

A relay system, a relay device, a computer-readable storage medium storing a program performs mutual conversion between a first message using a first higher protocol and a first lower protocol and a second message using a second higher protocol and a second lower protocol, transmits a combined message obtained by combining at least one second message, and supplies an extracted second message.

### CROSS REFERENCE TO RELATED APPLICATION

The present application claims the benefit of priority from Japanese Patent Application No. 2024-045092 filed on Mar. 21, 2024. The entire disclosure of the above application is incorporated herein by reference.

### TECHNICAL FIELD

The present disclosure relates to a technology for relaying data between multiple electronic control units.

### BACKGROUND

In an in-vehicle network that employs a zone architecture, ECUs that use CAN communication are connected under a zone ECU, and the zone ECUs and the zone ECUs and the central ECU are connected by a bus that is faster than CAN, such as Ethernet or CAN FD. The CAN and Ethernet are registered trademarks. When CAN communication frames, which are slow and have small message sizes, are relayed sequentially over Ethernet or CAN FD, communication efficiency decreases.

A comparative technology for packing multiple CAN messages into an Ethernet frame and relaying the messages has been known.

### SUMMARY

A relay system, a relay device, a computer-readable storage medium storing a program performs mutual conversion between a first message using a first higher protocol and a first lower protocol and a second message using a second higher protocol and a second lower protocol, transmits a combined message obtained by combining at least one second message, and supplies an extracted second message.

### BRIEF DESCRIPTION OF THE DRAWINGS

The above and other features and advantages of the present disclosure will become more apparent from the following detailed description made with reference to the accompanying drawings, in which like parts are designated by like reference numbers.

FIG. 1 is a block diagram showing a configuration of an in-vehicle system.

FIG. 2 is an explanatory diagram showing a combination of communication protocols used in the in-vehicle system.

FIG. 3 is an explanatory diagram showing an outline of processes in a central ECU and a zone ECU.

FIG. 4 is an explanatory diagram showing a configuration of a communication frame.

FIG. 5 is a sequence diagram of communication from an external tool to an end ECU in a first embodiment in which multiple messages related to the same end ECU are packed in the same frame.

FIG. 6 is a sequence diagram of communication from an end ECU to an external tool in the first embodiment.

FIG. 7 is a sequence diagram for controlling the transmission interval of frames addressed to an end ECU.

FIG. 8 is a sequence diagram for controlling the number of frames that can be transmitted to an end ECU without confirmation.

FIG. 9 is a sequence diagram of communication from an external tool to a end ECU in a second embodiment in which multiple messages related to multiple end ECUs are packed in the same frame.

FIG. 10 is a sequence diagram of communication from the end ECU to the external tool in the second embodiment.

### DETAILED DESCRIPTION

Meanwhile, DoIP, which is a diagnostic communication in Ethernet, is becoming widespread. However, at present, there are many ECUs in vehicles that only have CAN as a communication interface. The CAN is a registered trademark. Therefore, in order to diagnose an ECU with an external Ethernet tool that uses DoIP, it is necessary to perform protocol conversion between DoIP and DoCAN.

However, as a result of detailed consideration by the inventors, the conventional technology described in Patent Literature 1 simply packs messages and converts lower layer protocols (hereinafter, lower protocols). Therefore, when the conventional technology is applied to a relay system in which various higher layer protocols (hereinafter referred to as higher protocols) are used, a difficulty has been found in that the functionality is insufficient.

One example of the present disclosure provides a technology for improving the communication efficiency in a relay system that uses multiple types of lower protocols with different communication speeds and involves conversion of a higher protocol.

According to one example embodiment of the present disclosure, a relay system relays communication between a first electronic device and a second electronic device, and includes a first relay device and a second relay device. The first relay device is connected to the first electronic device by a first lower protocol, configured to transmit and receive data to and from the first electronic device by using a first higher protocol, and configured to transmit and receive data to and from the second electronic device by using a second higher protocol. The second relay device is connected to a second electronic device by a second lower protocol, and is connected to the first relay device by a third lower protocol that uses a frame having a longer payload than the second lower protocol.

The first relay device includes a protocol conversion unit, a first packing unit, and a first unpacking unit. The protocol conversion unit is configured to perform mutual conversion between a first message using the first higher protocol and the first lower protocol and a second message using the second higher protocol and the second lower protocol. The first message is transmitted to and received from the first electronic device. The first packing unit is configured to transmit a combined message obtained by combining at least one second message supplied from the protocol conversion unit to the second relay device by the third lower protocol. The first unpacking unit is configured to extract the at least one second message from the combined message received from the second relay device by the third lower protocol and supply the at least one extracted second message to the protocol conversion unit.

The second relay device includes a second packing unit and a second unpacking unit. The second packing unit is configured to transmit the combined message obtained by combining the at least one second message received from the second electronic device to the first relay device by the third lower protocol. The second unpacking unit configured to individually transmit, to the second electronic device, the at least one second message obtained by unpacking the combined message received from the first relay device by the third lower protocol.

According to such a configuration, it is possible to improve communication efficiency in a relay system that uses multiple types of lower protocols with different communication speeds and involves conversion of higher protocols. One aspect of the present disclosure is a relay device. The relay device configures a relay system for relaying communication between a first electronic device and a second electronic device together with a sub-relay device that is connected to a first electronic device by a first lower protocol and to a second electronic device by a second lower protocol.

The relay device includes a protocol conversion unit, a packing unit, and an unpacking unit. The protocol conversion unit is configured to perform mutual conversion between a first message using the first higher protocol and the first lower protocol and a second message using the second higher protocol and the second lower protocol. The first message is transmitted to and received from the first electronic device. The packing unit configured to transmit a combined message obtained by combining at least one second message supplied from the protocol conversion unit to the sub-relay device by the third protocol using a frame having a longer payload than the second lower protocol; and The unpacking unit is configured to extract the at least one second message from the combined message received from the sub-relay device by the third lower protocol and supply the at least one extracted second message to the protocol conversion unit.

The relay device configured in this manner can be used as the first relay device constituting the relay system described above. One aspect of the present disclosure is a program for causing a computer to function as a first relay device and a second relay device constituting the relay system described above.

By executing such a program, it is possible to obtain the same effect as the relay system described above.

Hereinafter, embodiments of the present disclosure will be described with reference to drawings.

### 1. FIRST EMBODIMENT

### 1-1. Configuration

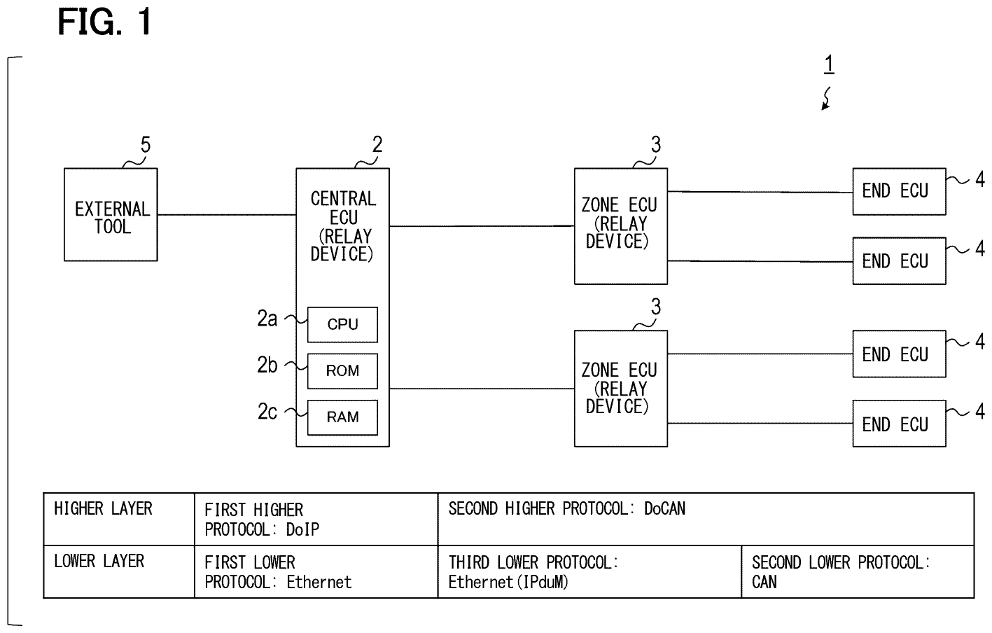

As shown in FIG. 1, an in-vehicle system 1 of the present embodiment is mounted on a vehicle. The vehicle may have an automated driving function in addition to a manual driving function. The vehicle may be a hybrid vehicle having an engine and an electric motor as a traveling source. The vehicle is not limited to the vehicle having the automated driving function or the hybrid vehicle, but may be a vehicle having only a manual driving function, or a vehicle having only an engine or only an electric motor as the traveling source. Hereinafter, the vehicle equipped with the in-vehicle system 1 will be simply referred to as a vehicle.

The in-vehicle system 1 includes one relay device (hereinafter, central ECU) 2, multiple relay devices (hereinafter, zone ECUs) 3, and multiple ECUs (hereinafter, end ECUs) 4. The ECU is an abbreviation for Electronic Control Unit.

The central ECU 2 controls the multiple zone ECUs 3 to implement a coordinated control of the entire vehicle. The central ECU 2 is connected to multiple zone ECUs 3 via a higher layer network. The higher layer network may be, for example, Ethernet. The Ethernet is a registered trademark. The central ECU 2 has a port for connecting an external tool 5. The external tool 5 diagnoses, for example, the ECUs 2 to 4. The central ECU 2 and the external tool 5 are connected to each other using, for example, Ethernet.

The zone ECU 3 is provided for each zone that divides the area inside the vehicle, and mainly controls multiple end ECUs 4 that exist within that zone. Each zone ECU 3 is connected to a subordinate end ECU 4 via a lower layer network that is individually provided for each zone ECU 3. The lower layer network may be, for example, a CAN. The CAN is a registered trademark and is an abbreviation for Controller Area Network.

The data length of one frame is a maximum of 8 bytes in CAN and a maximum of 1500 bytes in Ethernet. When Ethernet supports jumbo frames, the data length of one frame is a maximum of 9216 bytes.

The central ECU 2 is an electronic control unit mainly including a microcomputer including a CPU 2a, a ROM 2b, a RAM 2c, and the like. Various functions of the microcomputer are implemented by the CPU 2a executing programs stored in a non-transitory tangible storage medium. In this example, the ROM 2b corresponds to a non-transitory tangible storage medium that stores a program. Further, by executing this program, a method corresponding to the program is executed. Note that partial or all of the functions executed by the CPU 2a may be implemented by a hardware circuit, such as one or more ICs. Furthermore, the number of microcomputers constituting the central ECU 2 may be one or more.

In the following, the protocol used to connect the central ECU 2 and the external tool 5 is referred to as a first lower protocol, the protocol used to connect the zone ECU 3 and the end ECU 4 is referred to as a second lower protocol, and the protocol used to connect the central ECU 2 and the zone ECU 3 is referred to as a third lower protocol. The protocol used for transmitting and receiving data between the central ECU 2 and the external tool 5 is referred to as a first higher protocol. The protocol used for transmitting and receiving data between the central ECU 2 and the end ECUs is called a second higher protocol. Hereinafter, the first lower protocol and the first higher protocol are collectively referred to as external protocols, and the second lower protocol and the second higher protocol are collectively referred to as end protocols.

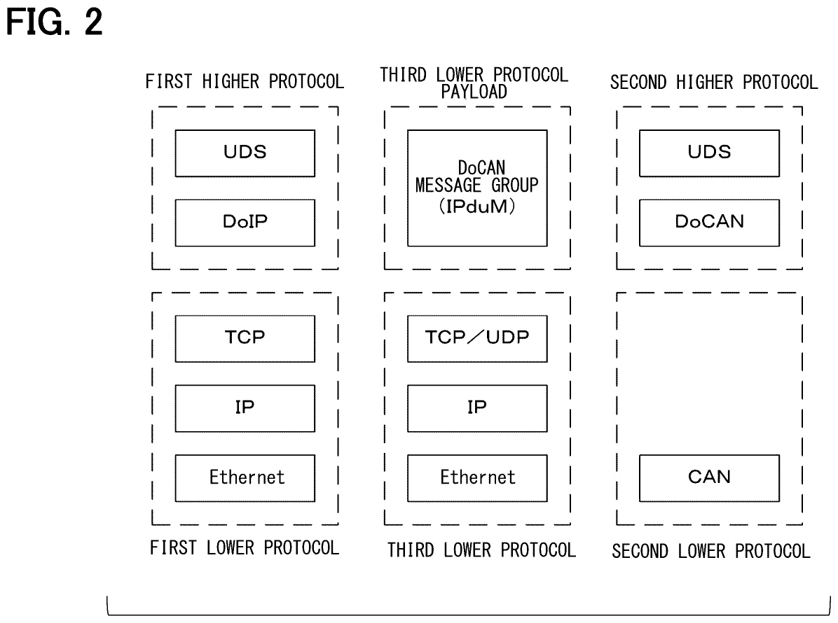

As shown in FIG. 2, in the present embodiment, the first lower protocol is TCP, IP, and Ethernet, the second lower protocol is CAN, and the third lower protocol is TCP/UDP, IP, and Ethernet. The payload of the third lower protocol uses AUTOSAR's IPduM, and one or more frames transmitted and received between the zone ECU 3 and the end ECU 4 are packaged. The first higher protocol is UDS and DoIP. The second higher protocol is UDS or DoCAN.

The UDS is an abbreviation for Unified Diagnostic Services, which is a unified diagnostic service for automobiles standardized by ISO14229. The DolP is an abbreviation for Diagnostics over Internet Protocol, and is an Ethernet-based diagnostic protocol standardized by ISO13400. The DoCAN is an abbreviation for Diagnostic communication over Controller Area Network, and is a CAN-based diagnostic protocol standardized by ISO15765. The AUTOSAR is an abbreviation for AUTomotive Open System ARchitectur, and a platform specification aimed at standardizing in-vehicle software. The IPduM is an abbreviation for Interaction layer Protocol Data Unit Multiplexer.

### 1-2. Overview of Processes by Central ECU and Zone ECU

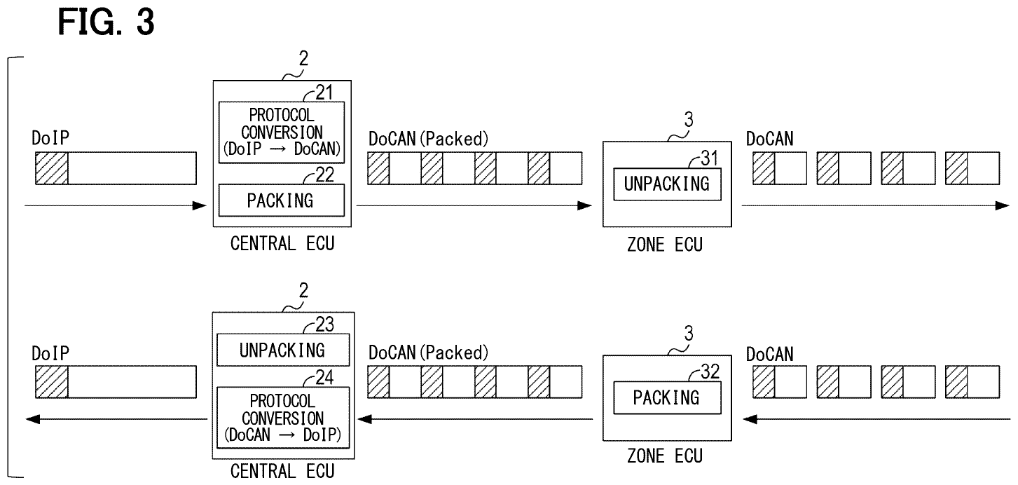

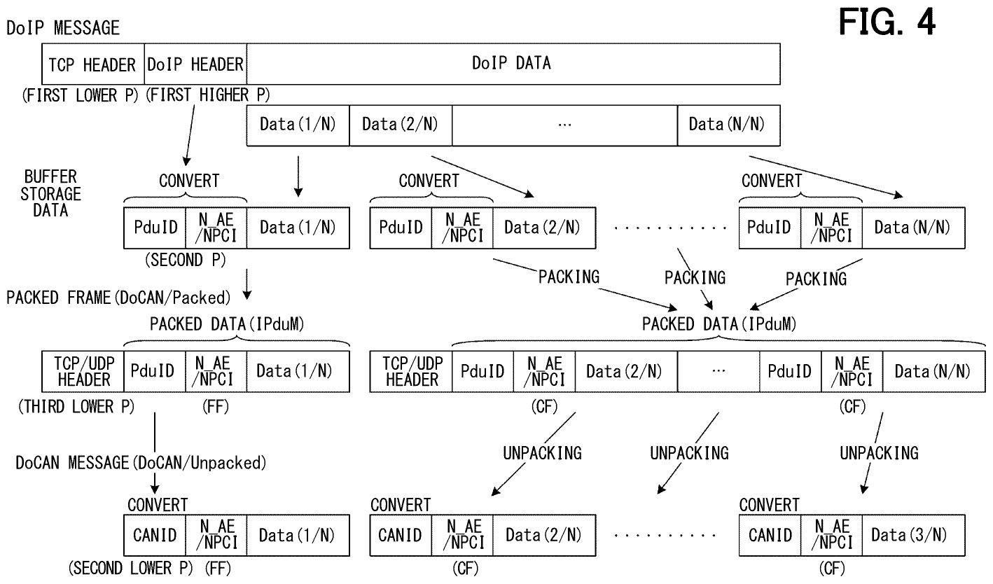

The processes executed by the central ECU 2 and the zone ECU 3 will be outlined with reference to FIGS. 3 and 4.

The central ECU 2 receives a DoIP message from the external tool 5. As shown in FIG. 4, the DolP message is transmitted in a TCP frame and includes a DolP header and DoIP data. In FIG. 4, descriptions regarding protocols lower than TCP are omitted.

When receiving the DoIP message from the external tool 5, the central ECU 2 executes a protocol conversion process 21 and a packing process 22. The protocol conversion process 21 is a process for converting the DolP message into the DoCAN message. Specifically, when the central ECU 2 receives the DolP message, it divides the DoIP data into N pieces of data each having a length that can be transmitted by CAN, which is the second lower protocol. The N is an integer of 1 or more. Hereinafter, the divided DoIP data will be referred to as division data. The data length of the division data is set to, for example, a length obtained by subtracting, from the data length of the CAN data (i.e., 8 bytes), the area length of the N_AE/NPCI described later (for example, 1 byte in the case of a CF in a normal fixed addressing format). The central ECU 2 converts the information in the DoIP header into PduID and N_AE/NPCI, which are header information used in the second protocol. Furthermore, the central ECU 2 generates N DoCAN messages by adding the converted header information to each of the N pieces of division data, and stores the generated messages in a transmission buffer.

The PduID is set based on the type of message contained in the DoIP header. The PduID may be associated with the CAN ID on a one-to-one basis. The PduID may be the CAN ID itself.

When the N_AE is used, it may contain address information contained in the DoIP header. The NPCI includes identification information indicating whether the DoCAN message is SF, FF, CF, or FC. Whether N_AE is used and the format of N_AE and NPCI depend on the addressing used in DoCAN. The SF indicates that the message is the DoCAN message used when transmitting data that is completed in one frame. The FF indicates that this is the first DoCAN message to be transmitted, and is used when transmitting data that is not completed in one frame. The CF is used when transmitting data that is not completed in one frame, and indicates that it is a subsequent DoCan message following FF. The FC is used when receiving data that is not completed in one frame, and indicates that the message is a DoCan message transmitted by the receiver for arbitration regarding the exchange of subsequent DoCan messages. Hereinafter, the DoCAN message in which the SF is indicated will be referred to as a SF message. The same is true for FF, CF, and FC.

When the division number N of the DoIP data is 1 (for example, when the data length of the DoIP data is 7 bytes or less), the SF message is used. When the division number N of the DoIP data is 2 or more (that is, when the data length of the DoIP data is 8 bytes or more), the FF message is used for the first DoCAN message, and a CF message is used for the subsequent DoCAN messages.

The packing process 22 is a process of packing one or more DoCAN messages generated by the protocol conversion process 21 into a frame (hereinafter, packed frame) of the third lower protocol (i.e., TCP/UDP) and transmitting the packed frame to the zone ECU 3. Specifically, for the SF message, FF message, and FC message, the central ECU 2 generates a packed frame in which the DoCAN message is packed alone. For the CF message, the central ECU 2 generates the packed frames in which the CF message is packed, as many as the data area of the packed frame allows, or generates a specified number of packed frames. In other words, the packed frame in which multiple CF messages are packed may be generated from one DoIP message.

When the zone ECU 3 receives the packed frame from the central ECU 2, the zone ECU 3 executes an unpacking process 31. The unpacking process 31 is a process of unpacking one or more DoCAN messages packed in the packed frame to extract the messages and transmit the messages to the end ECU 4. The zone ECU 3 performs ID conversion for each of the extracted DoCAN messages to convert the PduID into the CAN ID, and transmits the message to the end ECU 4. When multiple CF messages are extracted, each CF message is transmitted in sequence at a preset transmission interval.

When the zone ECU 3 receives the DoCAN message from the end ECU 4, the zone ECU 3 executes a packing process 32. The packing process 32 is a process of packing one or more DoCAN messages received from the end ECU 4 into a data area of a packed frame and transmitting the packed frame to the central ECU 2. Specifically, when the received DoCAN message is the SF message, the FF message, or the FC message, the zone ECU 3 generates the packed frame in which the DoCAN message is packed alone. When the received DoCAN message is the CF message, or when a waiting time has elapsed or the number of received CF messages has reached an upper limit, the packed frame is generated in which all the CF messages received from the end ECU 4 during that time are packed. When a subsequent CF message is received during the waiting time, the waiting time may be updated or extended. In other words, the CF messages that are received consecutively at intervals within the waiting time may be packed within the range of the maximum data length that can be transmitted in a lower frame of the third lower protocol.

When the central ECU 2 receives the packed frame from the zone ECU 3, it executes an unpacking process 23 and a protocol conversion process 24. The unpacking process 23 is a process for extracting individual packed DoCAN messages by unpacking the packed frames.

The protocol conversion process 24 is a process for converting the DoCAN message into the DolP message. Specifically, when the extracted DoCAN message is the SF message, the central ECU 2 generates the DoIP message in which the CAN data extracted from the SF message is used as DoIP data, and transmits the DoIP message to the external tool 5. When the extracted DoCAN message is the FF message or the CF message, the central ECU 2 sequentially stores the DoCAN data extracted from the FF message and the CF message in a message buffer. When a message transmission condition is satisfied, the central ECU 2 generates the DolP message in which the CAN data stored in the message buffer is DoIP data, and transmits the DolP message to the external tool 5. The message transmission condition may include a condition that an upper limit time has elapsed from the start of storing DoCAN data in the message buffer, and a condition that the data length of the CAN data stored in the message buffer has reached an upper limit value of the TCP segment for transmitting the DoIP message.

The zone ECU 3 only packs and unpacks the DoCAN message and transfers it. The protocol process related to DoCAN between the zone ECU 3 and the end ECU 4 is executed by the central ECU 2.

In the present embodiment, the central ECU 2 and the zone ECU 3 individually execute the above-described process for each end ECU 4 identified by the DoIP header, CAN ID/PduID, N_AE, and the like.

### 1-4. Overall Operation)

### 1-4-1. Communication from External Tool to End ECU

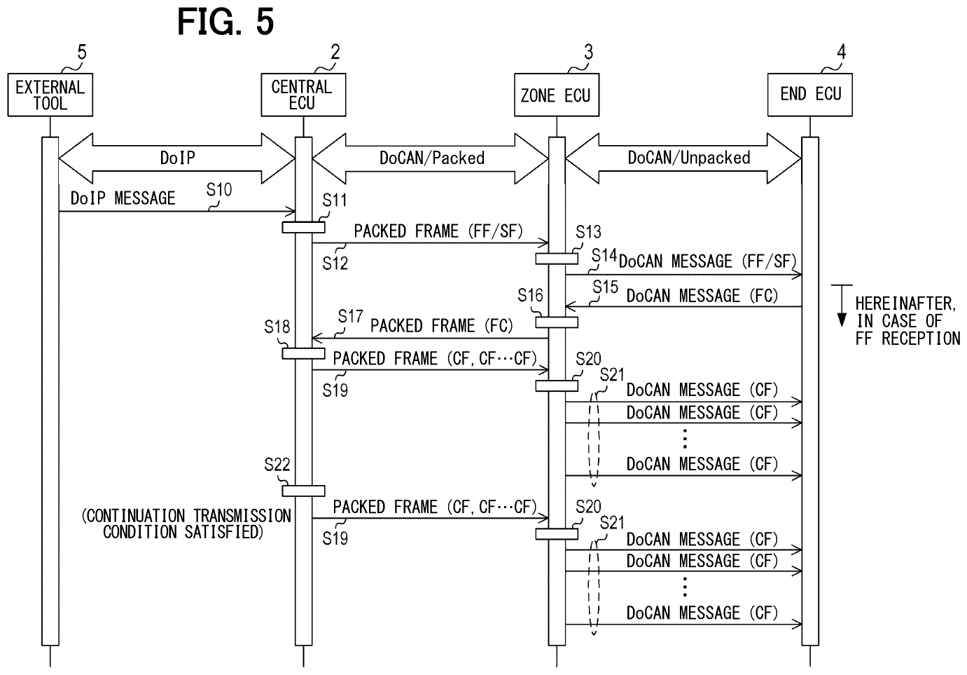

Next, an operation of the in-vehicle system 1 when the DoIP message is transmitted from the external tool 5 to the end ECU 4 will be described with reference to a sequence diagram of FIG. 5.

In S10, the external tool 5 transmits the DoIP message to the central ECU 2.

When the central ECU 2 receives the DolP message, in S11, it divides the DoIP data to generate one or more DoCAN messages, and stores the generated DoCAN messages in a transmission buffer. When the DoCAN message stored at the top of the transmission buffer is the SF or FF message, the central ECU 2 generates the packed frame in which the FF or SF message is packed alone in S12 and transmits the packed frame to the zone ECU 3.

When the zone ECU 3 receives the packed frame, in S13, it extracts the DoCAN message from the packed frame and converts the PduID into the CAN ID. In S14, the zone ECU 3 transmits the ID-converted DoCAN message to the end ECU 4.

When the DoCAN message received from the zone ECU 3 is an FF message, the end ECU 4 generates the FC message and transmits the FC message to the zone ECU 3 in S15. It should be noted that when the DoCAN message received from the zone ECU 3 is an SF message, there is no need to transmit the FC message. Therefore, the following description will be given of the operation when the end ECU 4 receives the FF message.

When the zone ECU 3 receives the FC message from the end ECU 4, in S16, the zone ECU 3 generates the packed frame in which the FC message is packed alone. In S17, the zone ECU 3 transmits the generated packed frame to the central ECU 2.

When the central ECU 2 receives the packed frame in which the FC message is packed, the central ECU 2 generates the packed frame in which one or more CF messages are packed in S18.

In S19, the central ECU 2 transmits the generated packed frame to the zone ECU 3. When the zone ECU 3 receives the packed frame, in S20, it extracts multiple CF messages from the packed frame and converts the CAN ID of each CF message into a PduID.

In S21, the zone ECU 3 transmits the ID-converted CF frames to the end ECU 4 in sequence at a set transmission interval. In S22, when a continuation transmission condition is satisfied, the central ECU 2 generates the packed frame by the same process as in S18, and transmits the generated packed frame to the zone ECU 3, as in S19. The continuation transmission condition may include a condition that the CF remains in the transmission buffer despite the result that the packed frame was transmitted in the previous S19 and also a certain time has elapsed since the previous transmission of the packed frame.

The central ECU 2 repeatedly executes the process of S22 until there are no more CF messages in the transmission buffer. The process in the zone ECU 3 that receives this packed frame is similar to the processes in S20 and S21 described above.

### 1-4-2. Communication from End ECU to External Tool

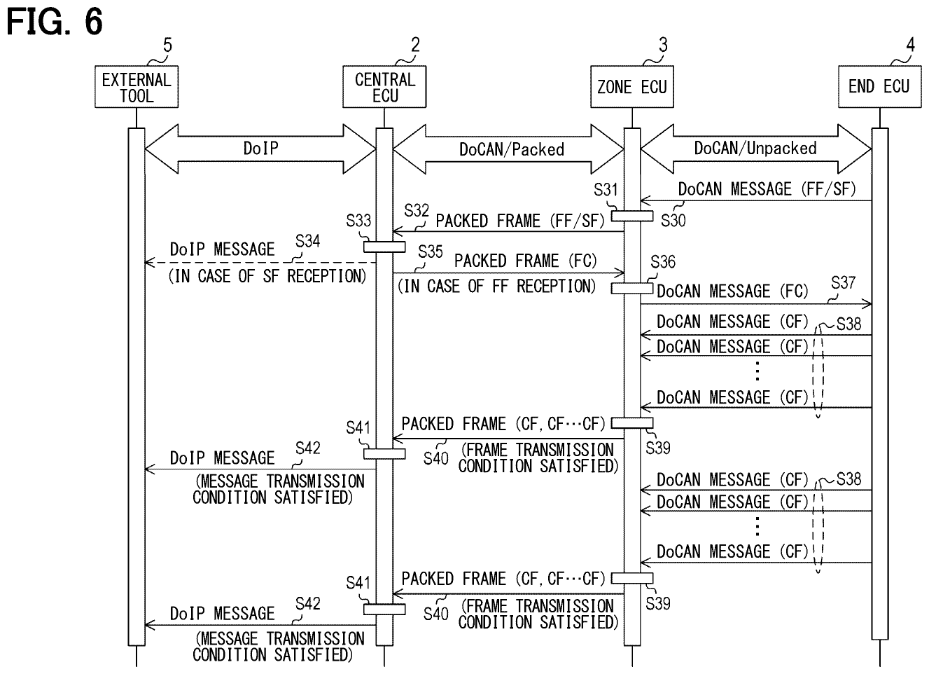

Next, an operation of the in-vehicle system 1 when transmitting the DoCAN message from the end ECU 4 to the external tool 5 will be described with reference to a sequence diagram of FIG. 6.

When there is data to be transmitted to the external tool 5, the end ECU 4 divides the data into pieces of a size that can be transmitted by one DoCAN message, and generates the DoCAN message. When the divided transmission data can be transmitted in the single DoCAN message, the SF message is generated, and when it is necessary to transmit the data in multiple DoCAN messages, the initial FF message and one or more subsequent CF messages are generated and stored in the transmission buffer.

In S30, the end ECU 4 transmits the DoCAN message stored at the top of the transmission buffer, i.e., the FF or SF message, to the zone ECU 3. When the zone ECU 3 receives the FF or SF message from the end ECU 4, in S31, the zone ECU 3 generates the packed frame in which the FF or SF message is packed alone.

In S32, the zone ECU 3 transmits the generated packed frame to the central ECU 2. When the central ECU 2 receives the packed frame from the zone ECU 3, in S33, it extracts the DoCAN message from the packed frame. When the extracted DoCAN message is the SF message, the central ECU 2 converts the DoCAN message into the DolP message. Then, the central ECU 2 transmits the DolP message to the external tool 5 in S34, as indicated by the dashed arrow in FIG. 6.

When the extracted DoCAN message is an FF message in the previous S33, the central ECU 2 starts generating DoIP data (i.e., restoring the transmission data) by storing the DoCAN data contained in the FF message in a message buffer.

Furthermore, the central ECU 2 generates the FC message that is a response to the FF message, and generates the packed frame in which the FC message is packed alone.

In S35, the central ECU 2 transmits the generated packed frame to the zone ECU 3. When the zone ECU 3 receives the packed frame from the central ECU 2, in S36, it extracts the FC message from the packed frame and converts the PdulD into the CAN ID.

In S37, the zone ECU 3 transmits the ID-converted FC message to the end ECU 4. When the end ECU 4 receives the FC message from the zone ECU 3, in S38, it transmits the DoCAN message stored in the transmission buffer, i.e., the CF message, to the zone ECU 3 continuously at the set transmission interval.

When the zone ECU 3 receives the CF message from the end ECU 4, it waits until a frame transmission condition is satisfied. When the frame transmission condition is satisfied, in S39, it generates the packed frame in which one or more CF messages received at that time are packed. The frame transmission condition may include, for example, a condition that a waiting time has elapsed since receiving the first CF frame, and a condition that the total length of multiple received CF messages reaches the upper limit of the data length that can be transmitted in the packed frame.

In S40, the zone ECU 3 transmits the generated packed frame to the central ECU 2. When the central ECU 2 receives the packed frame from the zone ECU 3, in S41, the central ECU 2 extracts multiple CF messages from the packed frame. Furthermore, the central ECU 2 extracts DoCAN data contained in each of the multiple CF messages, and stores the data in a message buffer. Furthermore, when the message transmission condition is satisfied, the central ECU 2 generates a DolP message that converts all the DoCAN data stored in the message buffer into DoIP data. The message transmission conditions may include a condition that the total data length of the data stored in the message buffer reaches an upper limit value of the TCP segment for transmitting the DoIP message, and a condition that a predetermined time has elapsed since the receipt of an FF message or the transmission of the previous DoIP message related to the FF message.

In S42, the central ECU 2 transmits the DolP message generated in S41 to the external tool 5. When the zone ECU 3 continues to receive CF messages from the end ECU 4 even after transmitting the packed frame in the previous S40, the zone ECU 3 repeats the processes described in the previous S39 and S40. Accordingly, the central ECU 2 also repeats the processes described above in S41 and S42.

### 1-4-3. Control of Transmission Interval of CF Message Addressed to End ECU

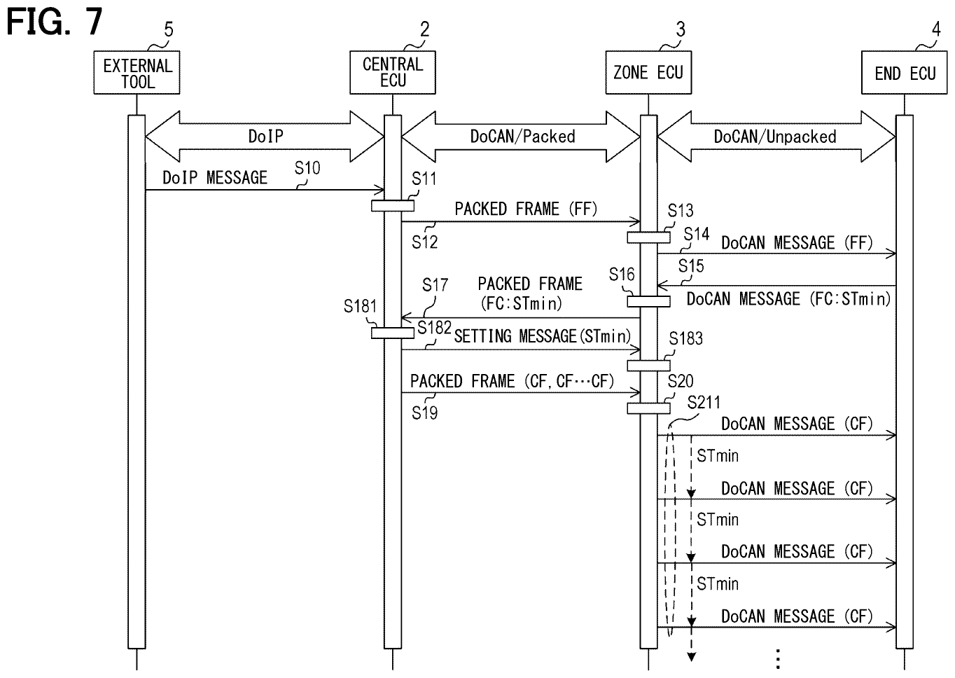

Next, an operation of the end ECU 4 in the in-vehicle system 1 when the end ECU 4 uses the FC message to control the reception interval of the CF message will be described with reference to a sequence diagram of FIG. 7. Basically, the operation is the same as that in the sequence diagram of FIG. 5, so the same processes and procedures are denoted by the same reference numerals and the description thereof will be omitted.

When the end ECU 4 receives the FF message from the zone ECU 3 in S14, the end ECU 4 sets a STmin parameter specifying the transmission interval of the CF message in the FC message that the end ECU 4 transmits to the zone ECU 3 in S15.

When the central ECU 2 receives the packed frame in which the CF message is packed via the zone ECU 3, in S181, it extracts the CF message from the packed frame to generate a setting message and also generates the packed frame in which one or more CF messages are packed.

The setting message is a message that instructs the zone ECU 3 to set the transmission interval of the CF message in accordance with the STmin parameter indicated in the FC message. The central ECU 2 transmits a setting message to the zone ECU 3 in S182. After that, when a sufficient time required for the setting message to be reflected in the zone ECU 3 has elapsed, the central ECU 2 transmits the packed frame in which one or more CF messages are packed to the zone ECU 3 in S19.

When the zone ECU 3 receives the setting message from the central ECU 2, the zone ECU 3 sets the transmission interval to be used for transmitting the CF message in accordance with the contents of the setting message in S183. Hereinafter, the set transmission interval is represented as STmin.

When the zone ECU 3 receives the packed frame in which one or more CF messages are packed from the central ECU 2, in S21, it extracts the CF messages from the packed frame, and in S211, it sequentially transmits the extracted one or more CF messages at the set transmission interval STmin. The initial value of STmin may be set arbitrarily.

### 1-4-4. Control of Number of Consecutive Receptions of CF Messages Addressed to End ECU

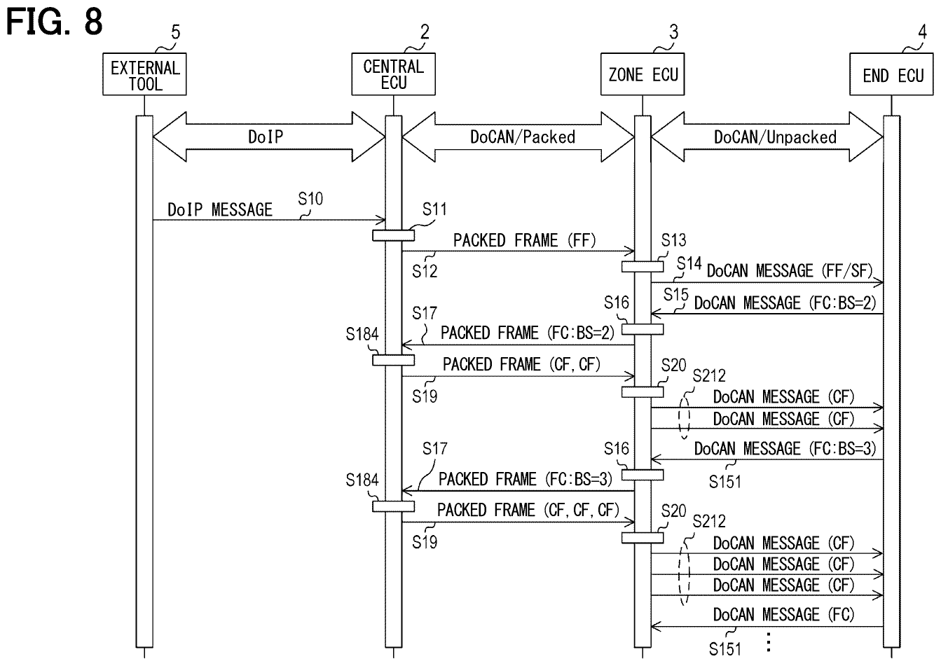

Next, an operation of the end ECU 4 in the in-vehicle system 1 when the end ECU 4 uses the FC message to control the number of consecutively received CF messages will be described with reference to the sequence diagram of FIG. 8. Basically, the operation is the same as that in the sequence diagram of FIG. 5, so the same processes and procedures are denoted by the same reference numerals and the description thereof will be omitted.

When the end ECU 4 receives the FF message from the zone ECU 3 in S14, the end ECU 4 sets a BS parameter specifying the number of consecutive CF messages to be received in the FC message to be transmitted to the zone ECU 3 in S15. Here, a relation of BS=2 is set.

When the central ECU 2 receives a packed frame in which the FC message is packed via the zone ECU 3 in S17, the central ECU 2 extracts the FC message from the packed frame in S184 and stores the value of the BS parameter indicated in the FC message. Thereafter, the central ECU 2 generates the packed frame in which the number of CF messages indicated by the BS parameter is packed.

In S19, the central ECU 2 transmits the packed frame generated in S184 to the zone ECU 3. When the zone ECU 3 receives the packed frame, it extracts the CF messages from the packed frame in S20, and transmits all of the extracted CF messages (i.e., two) to the end ECU 4 in sequence in S212.

When the end ECU 4 receives the number of CF messages, the number being indicated by the BS parameter of the previously transmitted FC message, it transmits the FC messages to the zone ECU 3 in S151. Here, it is assumed that the value of the BS parameter is changed to 3.

Thereafter, the processes of S16, S17, S184, S19, S20, and S212 are same. However, since BS is changed to 3, in S19, three CF messages are packed into the packed frame transmitted from the central ECU 2 to the zone ECU 3, and in S212, three CF messages are transmitted consecutively from the zone ECU 3 to the end ECU 4. In addition, the end ECU 4 that has received the three CF messages transmits the FC message to the zone ECU 3. Hereinafter, the same process is repeated. The initial values of the BS parameters may be set arbitrarily.

### 1-5. Correspondence of Terms

In the present embodiment, the central ECU 2 corresponds to a first relay device and a relay device of the present disclosure, the zone ECU 3 corresponds to a second relay device and a sub-relay device, the end ECU 4 corresponds to a second electronic device, and the external tool 5 corresponds to a first electronic device. In the present embodiment, the central ECU 2 that executes the protocol conversion processes 21 and 24 corresponds to a protocol conversion unit of the present disclosure, the central ECU 2 that executes the packing process 22 corresponds to a first packing unit of the present disclosure, and the central ECU 2 that executes the unpacking process 23 corresponds to a first unpacking unit of the present disclosure. In the present embodiment, the zone ECU 3 that executes the unpacking process 31 corresponds to a second unpacking unit of the present disclosure, and the zone ECU 3 that executes the packing process 32 corresponds to a second packing unit of the present disclosure. In the present embodiment, the second message packed by the packing processes 22 and 32 corresponds to a combined message of the present disclosure.

### 1-6. Effects

According to a first embodiment described in detail above, the following effects are achieved.

(1a) In the in-vehicle system 1, the central ECU 2 performs protocol conversion between the DolP message used for data exchange with the external tool 5 and the DoCAN message used for data exchange with the end ECU 4. Between the central ECU 2 and the zone ECU 3, which uses a lower protocol with a faster communication speed than between the zone ECU 3 and the end ECU 4, communication is performed using a packed frame in which one or more DoCAN messages are packed. Therefore, the in-vehicle system 1 can improve the efficiency of communication related to the diagnosis of the ECU.

(1b) The zone ECU 3 only packs and unpacks the DoCAN data, and the central ECU 2 executes processes in accordance with the DoCAN protocol, such as arbitration of control contents using FC messages. Therefore, it is possible to simply configure the zone ECU 3.

### 2. SECOND EMBODIMENT

### 2-1. Difference from First Embodiment

The fundamental configuration of a second embodiment is similar to that of the first embodiment. Therefore, the difference therebetween will be described below. The same reference numerals as in the first embodiment denote the same elements, and reference is made to the preceding description.

In the above-described first embodiment, the packed frame is generated by using the DoCAN message transmitted and received by one end ECU 4. In contrast, the second embodiment differs from the first embodiment in that the packed frame is generated using the DoCAN message transmitted and received by different end ECUs 4.

### 2-2. Communication from External Tool to Multiple End ECUs

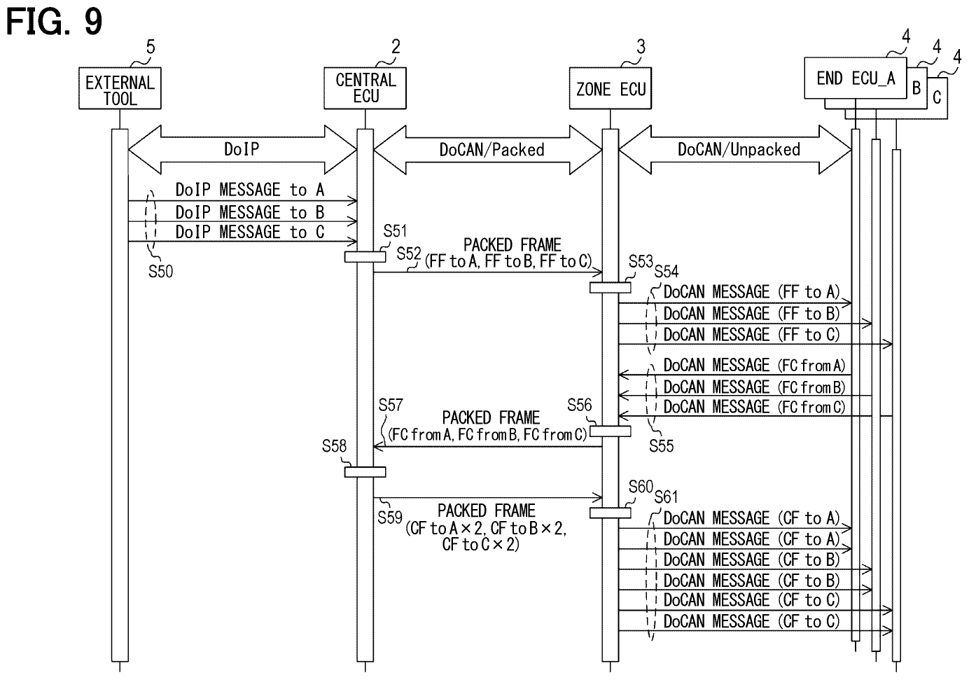

The operation of the in-vehicle system 1 when the DoIP message is transmitted from the external tool 5 to multiple end ECUs 4 under the same zone ECU 3 will be described with reference to the sequence diagram of FIG. 9. In the following description, multiple end ECUs 4 connected to the same zone ECU 3 will be referred to as a target ECU group.

In S50, the external tool 5 transmits multiple DoIP messages having different destinations to the central ECU 2. Here, a case will be described in which all of the end ECUs 4 belong to the target ECU group.

In S51, the central ECU 2 executes the protocol conversion process 21 for each received DoIP message to generate the DoCAN message, and stores the DoCAN message in the transmission buffer provided for each destination end ECU 4.

When the FF message or SF message is stored at the top of a transmission buffer addressed to the target ECU group, the central ECU 2 extracts the FF message or SF message and generates the packed frame by packing one or more of the collected FF messages or SF messages. FIG. 9 shows a case where FF messages are extracted from three end ECUs 4 identified as A, B, and C that belong to the target ECU group.

In S52, the central ECU 2 transmits the packed frame to the zone ECU 3. When the zone ECU 3 receives the packed frame from the central ECU 2, in S53, the zone ECU 3 extracts multiple FF messages from the packed frame and converts the PduID of each FF frame into a CAN ID.

In S54, the zone ECU 3 transmits each of the extracted FF messages to each of the end ECUs 4 that are destinations. When each end ECU 4 receives the FF message, it generates an FC message and transmits it to the zone ECU 3 in S55.

When the zone ECU 3 receives the FC message, in S56, the zone ECU 3 generates the packed frame in which all the FC messages received during a predetermined waiting time are packed. When another FC frame is received during the waiting time, the waiting time may be updated or extended.

In S57, the zone ECU 3 transmits the packed frame generated in S56 to the central ECU 2. When the central ECU 2 receives the packed frame from the zone ECU 3, in S58, it extracts one or more FC frames from the packed frame. The central ECU 2 sequentially extracts CF frames from a transmission buffer associated with the extracted FC frame according to a predetermined extraction rule. When a frame transmission condition is satisfied, the central ECU 2 generates the packed frame in which all the extracted CF data is packed. The frame transmission conditions are the same as those described in the first embodiment. The extraction rule may be, for example, to extract a specified number (e.g., two) of CF messages from all transmission buffers (hereinafter, the target transmission buffer group) that are linked to the target ECU group and in which CF messages are stored. Alternatively, the extraction rule may be to extract CF buffers one by one in order from the target transmission buffer group, and repeat this process until the total length of the extracted CF messages reaches the upper limit data length.

In S59, the central ECU 2 transmits the packed frame generated in S58 to the zone ECU 3. When the zone ECU 3 receives the packed frame, in S60, it extracts multiple CF messages from the packed frame and converts the PduID into the CAN ID.

In S61, the extracted CF messages are sequentially transmitted to the end ECUs 4 that are the destinations. Thereafter, while the CF message remains in the transmission buffer of the central ECU 2, the processes of S58 to S61 are repeatedly executed each time the continuation transmission condition is satisfied.

### 2-3. Communication from Multiple End ECUs to External Tools

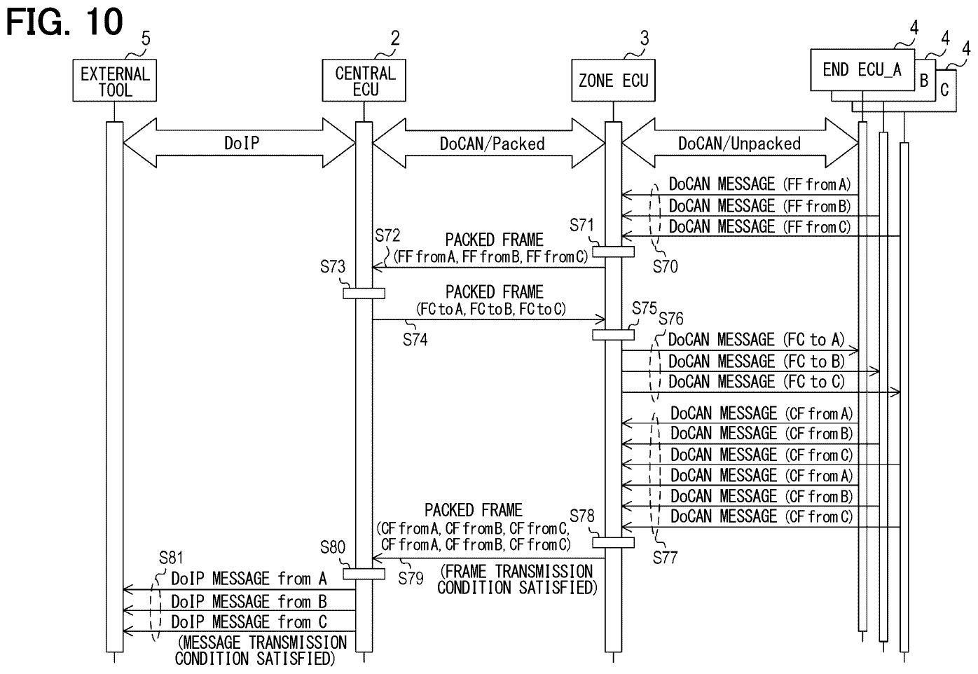

The operation of multiple end ECUs 4 under the control of the same zone ECU 3 in the in-vehicle system 1 when each of them transmits a DoCAN message to the external tool 5 will be described with reference to the sequence diagram of FIG. 10.

In S70, each end ECU 4 transmits the FF message to each zone ECU 3.

When the zone ECU 3 receives an FF message from any of the end ECUs 4, in S71, the zone ECU 3 generates a packed frame by packing all the FF frames received during a predetermined waiting time. When the zone ECU 3 receives another FF frame during the waiting time, the zone ECU 3 may update or extend the waiting time.

In S72, the zone ECU 3 transmits the packed frame generated in S71 to the central ECU 2. When the central ECU 2 receives the packed frame from the zone ECU 3, in S73, the central ECU 2 extracts multiple FF messages from the packed frame. The central ECU 2 stores the DoCAN data contained in each extracted FF message in the message buffer provided for each end ECU 4 that is the transmission source of the FF message. Furthermore, the central ECU 2 generates the FC message in response to each FF message, and generates the packed frame in which all the generated FC messages are packed.

In S74, the central ECU 2 transmits the packed frame generated in S73 to the zone ECU 3. When the zone ECU 3 receives the packed frame from the central ECU 2, in S75, it extracts multiple FC frames from the packed frame.

In S76, the zone ECU 3 transmits each FC frame to the end ECU 4 that is the destination.

When the end ECU 4 receives the FC message from the zone ECU 3, it starts transmitting the CF message in S77.

When the zone ECU 3 receives the CF message from the end ECU 4, in S78, it generates the packed frame that packs all the CF messages received from the end ECUs 4 belonging to the target ECU group until the transmission condition is satisfied. The transmission condition may be that a predetermined waiting time has elapsed, or that the total length of the received CF messages has reached the upper limit of the data length of the packed frame. When another CF message is received during the waiting time, the waiting time may be updated or extended.

In S79, the zone ECU 3 transmits the packed frame generated in S78 to the central ECU 2. When the central ECU 2 receives the packed frame from the zone ECU 3, in S80, it extracts multiple CF frames from the packed frame and stores the DoCAN data contained in each CF frame in a message buffer prepared for each end ECU 4 that is the transmission source of the packed frame. Furthermore, the central ECU 2 determines, for each message buffer, whether a message transmission condition is satisfied. When the message transmission condition is satisfied, the central ECU 2 generates the DolP message that treats the DoCAN data stored in the message buffer as DoIP data. The message transmission conditions are the same as those described in the first embodiment.

In S81, the central ECU 2 transmits the DolP message generated in S80 to the external tool 5. Thereafter, as long as the CF message remains in the message buffer, the processes of S80 to S81 are repeatedly carried out each time the continuation transmission condition is satisfied.

### 2-4. Effects

According to the second embodiment described above in detail, in addition to the effects (1a) and (1b) of the first embodiment described above, the following effects are also obtained.

(2a) In the present embodiment, packing of DoCAN messages is not performed for each end ECU 4, but DoCAN messages related to multiple end ECUs 4 connected to the same zone ECU 3 are packed into one packed frame.

Therefore, it is possible to further improve the efficiency of diagnostic communication.

### 3. OTHER EMBODIMENTS

Although the embodiments of the present disclosure has been described above, the present disclosure is not limited to the embodiment described above, and various modifications can be made to implement the present disclosure.

(3a) In the above embodiment, the central ECU 2 checks the settings of the BS parameter and the STmin parameter contained in the FC message and executes the necessary process. For example, instead of the central ECU 2, the zone ECU 3 may check the contents of the FC message before performing the packing process 32 and execute the necessary process without the path through the central ECU 2.

(3b) In the above embodiment, an example has been shown in which Ethernet is used as the third lower protocol and CAN is used as the second lower protocol. However, the third lower protocol only needs to have a faster communication speed than the second lower protocol. For example, when CAN is used as the second lower protocol, CAN FD, CAN XL, or Ethernet and IEEE 1722, and the like may be used as the third lower protocol. In addition, when Ethernet or CAN XL is used as the third lower protocol, CAN FD may be used as the second lower protocol. The CAN FD is an abbreviation for CAN with Flexible Data Rate. The CAN XL is an abbreviation for CAN with Extended Length. The IEEE 1722 is a transport protocol for time-sensitive applications. The data length of one frame is a maximum of 64 bytes for CAN FD and a maximum of 2048 bytes for CAN XL.

(3c) The ECUs 2 to 4 and the methods described in the present disclosure may be implemented by a dedicated computer provided by configuring a processor and memory programmed to perform one or more functions embodied by a computer program. Alternatively, the ECUs 2 to 4 and the methods described in the present disclosure may be implemented by a dedicated computer provided by configuring a processor with one or more dedicated hardware logic circuits. Alternatively, the ECUs 2 to 4 and the methods described in the present disclosure may be implemented by one or more dedicated computers configured by combinations of processors and memories programmed to perform one or more functions and processors configured by one or more hardware logic circuits. The computer program may be stored in a computer-readable non-transitory tangible storage medium as instructions to be executed by a computer. The method for implementing the functions of the respective units included in the ECUs 2 to 4 does not necessarily need to include software, and all of the functions may be implemented with the use of one or multiple hardware.

(3d) The multiple functions of one component in the above embodiment may be implemented by multiple components, or a function of one component may be implemented by multiple components. In addition, multiple functions of multiple components may be implemented by one component, or a single function implemented by multiple components may be implemented by one component. Part of the configuration of the above embodiment may be omitted. At least a part of the configuration in one embodiment may be added to or substituted for the configuration of another embodiment.

(3e) In addition to the relay system constituted by the central ECU 2 as the first relay device and the zone ECU 3 as the second relay device described above, the present disclosure can also be implemented in various forms, such as a program for causing a computer to function as a relay system, a non-transitory tangible storage medium such as a semiconductor memory on which this program is recorded, and a relay method.

What is claimed is:

1. A relay system for relaying communication between a first electronic device and a second electronic device, the system comprising:
a first relay device that
is connected to the first electronic device by a first lower protocol,
is configured to transmit and receive data to and from the first electronic device by using a first higher protocol, and
is configured to transmit and receive data to and from the second electronic device by using a second higher protocol; and
a second relay device that
is connected to the second electronic device by a second lower protocol and
is connected to the first relay device by a third lower protocol using a frame with a longer payload than the second lower protocol,
wherein
the first relay device includes:
a protocol conversion unit configured to perform mutual conversion between
a first message using the first higher protocol and the first lower protocol and a second message using the second higher protocol and the second lower protocol, the first message being transmitted to and received from the first electronic device;
a first packing unit configured to transmit a combined message obtained by combining at least one second message supplied from the protocol conversion unit to the second relay device by the third lower protocol; and
a first unpacking unit configured to
extract the at least one second message from the combined message received from the second relay device by the third lower protocol and
supply the extracted second message to the protocol conversion unit, and
the second relay device includes:
a second packing unit configured to transmit the combined message obtained by combining the at least one second message received from the second electronic device to the first relay device by the third lower protocol; and
a second unpacking unit configured to individually transmit, to the second electronic device, the at least one second message obtained by unpacking the combined message received from the first relay device by the third lower protocol.

2. The relay system according to claim 1, wherein
the first higher protocol is Diagnostics over Internet Protocol (DoIP), and
the second higher protocol is Diagnostic communication over Controller Area Network (DoCAN).

3. The relay system according to claim 1, wherein
the first lower protocol is Ethernet (registered trademark),
the second lower protocol is control area network (CAN, registered trademark) or CAN FD, and
the third lower protocol is any one of CAN flexible data rate (FD), CAN extended length (XL), Ethernet and Interaction layer Protocol Data Unit Multiplexer (IPduM) of automotive open system architecture (AUTOSAR), and Ethernet and IEEE (registered trademark) 1722.

4. The relay system according to claim 1, wherein
the first packing unit and the second packing unit are configured to determine whether the second message needs to be combined according to identification information that identifies a type of the second message.

5. The relay system according to claim 1, wherein
the second unpacking unit is configured to change a transmission interval used when transmitting a plurality of restored second messages to the second electronic device based on information transmitted from the first relay device.

6. The relay system according to claim 1, wherein
the second packing unit is configured to perform transmission to the first relay device when at least one of a condition that a total length of the combined second message reaches an upper limit value or a condition that a certain time has elapsed since a previous transmission is satisfied.

7. A relay device that configures a relay system for relaying communication between a first electronic device and a second electronic device together with a sub-relay device that is connected to the first electronic device by a first lower protocol and to the second electronic device by a second lower protocol, the relay device comprising:
a protocol conversion unit configured to perform mutual conversion between
a first message using a first higher protocol and the first lower protocol and a second message using a second higher protocol and the second lower protocol, the first message being transmitted to and received from the first electronic device;
a first packing unit configured to transmit a combined message obtained by combining at least one second message supplied from the protocol conversion unit to the sub-relay device by a third lower protocol using a frame having a longer payload than the second lower protocol; and
a first unpacking unit configured to
extract the at least one second message from the combined message received from a second relay device by the third lower protocol and
supply the at least one extracted second message to the protocol conversion unit.

8. A non-transitory computer-readable storage medium storing a program causing a computer to serve as:
a first relay device that
is connected to a first electronic device by a first lower protocol,
is configured to transmit and receive data to and from the first electronic device by using a first higher protocol, and
is configured to transmit and receive data to and from a second electronic device by using a second higher protocol; and
a second relay device that
is connected to the second electronic device by a second lower protocol, and
is connected to the first relay device by a third lower protocol using a frame having a longer payload than the second lower protocol, and
constitutes, together with the first relay device, a relay system for relaying communication between the first electronic device and the second electronic device,
wherein
the first relay device includes:
a protocol conversion unit configured to perform mutual conversion between a first message using the first higher protocol and the first lower protocol and a second message using the second higher protocol and the second lower protocol, the first message being transmitted to and received from the first electronic device;
a first packing unit configured to transmit a combined message obtained by combining at least one second message supplied from the protocol conversion unit to the second relay device by the third lower protocol; and
a first unpacking unit configured to
extract the at least one second message from the combined message received from the second relay device by the third lower protocol and
supply the extracted second message to the protocol conversion unit, and
the second relay device includes:
a second packing unit configured to transmit the combined message obtained by combining the at least one second message received from the second electronic device to the first relay device by the third lower protocol; and
a second unpacking unit configured to individually transmit, to the second electronic device, the at least one second message obtained by unpacking the combined message received from the first relay device by the third lower protocol.
